(19) United States
(12) Patent Application Publication
(10) Pub. No.: US 2008/0006415 A1
(43) Pub. Date: Jan. 10, 2008

(54) MULTI-PURPOSE TOOLHOLDER ATTACHING TO THE REAR PART OF A CARRIER

(75) Inventors: Roger PELLENC, Pertuis (FR); Jean-Marc GIALIS, Cheval Blanc (FR)

Correspondence Address: EGBERT LAW OFFICES, 412 MAIN STREET, 7TH FLOOR, HOUSTON, TX, 77002, US

(73) Assignee: PELLENC, Societe Anonyme, Pertuis (FR)

(21) Appl. No.: 11/764,609

(22) Filed: Jun. 18, 2007

(30) Foreign Application Priority Data
Jun. 19, 2006 (FR) 06/05427

(51) Int. Cl. A01B 63/32

(52) U.S. Cl. 172/311; 172/2; 172/830

(57) ABSTRACT

Multi-purpose toolholder, attaching onto the rear part of a carrier, for example the rear part of an agricultural tractor, includes a mounting chassis whose bottom part is arranged to permit attachment in a removable manner or not and positioning in the rear part of a carrier. The mounting chassis includes at least one load-bearing frame extending upward, in the rear of the tractor and mounted thereon, and at least one bearing structure equipped with a toolholder head and oriented toward the front considering the direction of travel of the tool suspended from the toolholder head while working. The bearing structure is arranged so as to permit movements of the toolholder head in three directions and the travel of the toolholder head and tool suspended therefrom in a space located in the front and/or on at least one side of the tractor.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention concerns a multi-purpose tool holder attaching to the rear part of a carrier. Under an especially interesting but not exclusive application, the tool holder under the invention is attached in a removable manner to the rear part of an agricultural tractor, such as for example, a vineyard row-crop tractor.

2. Description of Related Art Including Information Disclosed Under 37 CFR 1.97 and 37 CFR 1.98.

Looking at the application to the field of equipment intended for various farming work, there are, at the present time, three methods for attaching tool holder frames onto the various types of tractor models:

1. Rear Three-Point Attachment

By far the most commonly used, it remains the favorite position for the manufacturers of various equipment available for viticulture or arboriculture.

It is today the only standard attachment on tractors that allows for fairly quick adjustments, and it is the most commonly used on all combined tractor models.

In some cases, mobility in the vertical direction (top-bottom) of the three-point attachment is a major disadvantage, especially if the system is of the single-acting type and is not designed to be subject to bottom to top stresses, which makes certain modifications necessary, such as blocking the three-point mobility through additional locking tie rods so as to secure position keeping at all times.

2. Front Attachment

This hitching position (for example, shown in French Patent No. 2,794,607) ranks second among manufacturers behind the rear three-point attachment. It is anyhow widely used as it is located in the front of the tractor and, for obvious reasons, this position offers great visibility of the tools at work with comfortable driving.

However, the disadvantages of such positioning are multiple.

Hitching a tool holder frame to the front of the tractor, i.e., onto the front axle fitting, poses visibility problems both on the road and in the field, that are becoming harder to solve in view of new European safety standards. In addition, it is important to perform the adjustment successfully by integrating all the stresses of the tractor itself, i.e. making sure not to obstruct the front grate of the engine hood so as to allow for the various coolers to vent normally, making sure to offset sufficiently the frame so that it is cantilevered toward the front so as to permit the opening of the engine hood to service the tractor without having to remove the tool holder frame, and to make sure not to exceed the critical loads onto the front axle and the attachments, as specified by the manufacturer. The critical loads are sometimes too little, especially since the marketing development of the new four-wheel drive steering systems with a small turning radius slims down the front part of the tractor and leaves little space for a tool holder and/or machine sturdy attachment.

3. Left or Right Side Attachment

This hitching position, also called between-wheel hitch is most often used to fit small size tools of the tillage tool type.

The attachment points on the tractor are not many, and it almost always proves necessary to custom-design a frame suitable for the type of tractor and its manufacturer. This mounting type is not very economical because the adjustment usually made by the retailers remains expensive because it is “custom-made”. This solution does not suit a multi-purpose application at all. In addition, the position of the tractor side attachment, located between the front and rear wheels, is used for access to the tractor cabin that are mostly either on the right or left of the latter, which poses some problems with side adjustment of the tools, like the presence of the tractor cabin access step or door opening, or the muffler outlet in a low position under the cabin step.

These problems are not insurmountable but change completely from one tractor model to another, which makes any industrial adjustment of the tools practically impossible using a side attachment frame.

In brief, there exists today no tool holder attachment standard, whether in the front, rear, or on the right or left side of a tractor. Moreover, the latest innovations regarding four-wheel drive steering systems make it very hard to adjust the frame for front attachment, even sometimes making it impossible.

The rear three-point hitch is currently the only existing standard interface on tractors that can be used as an attachment without two many specific characteristics among the various models. This is why the different and varied tools used for viticulture or arboriculture are mounted in priority onto the rear three-point attachment of the tractor and therefore mobilize it for the whole duration of execution a given job requiring the use of a specific tool. Tying-up the rear three-point attachment is a significant disadvantage because it prohibits simultaneous mounting of tools for performance of combined jobs, of the tillage type, most of which also attach on the rear three-point of vineyard row-crop tractors.

This situation constitutes a significant obstacle to the wishes of grape and tree growers who seek to optimize and maximize returns on their machine and equipment fleets as well as the work performed using the latter. This is why the world of viticulture and arboriculture is still waiting for solutions making it possible to optimize the work done in vineyards and orchards. To meet this general wish, the concept of a “multi-purpose toolholder frame” has become a priority for all major manufacturers (see, for example, French Patent No. 2,817,112 and 2,817,114).

This invention proposes to make available, to interested professional users, a multi-purpose toolholder attaching onto the rear part of a carrier, more specifically onto the rear part of an agricultural tractor and, in an even more interesting manner, the rear of a vineyard row-crop tractor. This new concept of a multi-purpose toolholder permitting the free concomitant use of the tractor three-point attachment, without disassembling or reassembling such frame and permitting combined work, work with side tools (for example with a pre-pruner of the type described in French Patent No. 2,554,675), or work with front tools (for example with a two half-row topper).

### BRIEF SUMMARY OF THE INVENTION

The multi-purpose toolholder under the invention comprises a frame, the bottom part of which is arranged to permit its attachment in a removable manner or not and its positioning in the rear part of a carrier. The frame comprises at least one load-bearing structure equipped with a toolholder head installed at the free end of said bearing structure and laid out so as to permit interchangeable attachment of tools designed for various agricultural jobs. The bearing structure is connected to the upper part of said frame and oriented toward the front, considering the direction of travel of the tool suspended from said toolholder head while working. The toolholder distinguishes itself in that the support structure is arranged so as to permit on one hand movements of the toolholder head in three directions, i.e.: vertically (top to bottom and conversely), laterally (left to right and vice-versa), and longitudinally (back to front and conversely), and; on the other hand, the travel of the toolholder head and tool suspended from it in a space located in the front and/or on at least one side of the tractor.

This multi-purpose toolholder has, among other things, the advantage of permitting perfect visibility whether on the front, rear, left or right side of the tractor or any other carrier so as to best meet the European standards and national rules on road traffic. In addition, it offers many working possibilities, regarding the use of straddling tools positioned laterally, such as a pre-pruner, or the use of row-crop tools, such as a two half-row topper positioned in the front of the tractor.

According to an advantageous embodiment, the toolholder head is attached to self-positioning means ensuring the auto-paralleling of the working axis of the tool carried by said toolholder head with the tractor axis when working, regardless of the position of said toolholder head in relation to the tractor.

According to a preferred embodiment, the chassis of the toolholder under the invention comprises means of attachment for its mounting in a removable manner or not onto a fixed rear element of the tractor chassis, independent of the rear three-point attachment system and is shaped so as to clear access to said three-point attachment system of said tractor whenever the toolholder is installed on the latter.

The multi-purpose toolholder thus allows for full use of the tractor rear three-point attachment system that remains available for mounting and (concomitant or not) use of any machine or tool combined with that of the tool carried by said toolholder chassis.

In addition, this toolholder can be attached in a permanent manner to the rear of the tractor, without having to remove it upon completion of a job since it does not in any way hinder the use of the tractor for various jobs that do not involve the mounting of a specific tool onto said toolholder.

According to a preferred embodiment, the bearing structure consists of an extendable bearing arm oriented toward the front, considering the direction of travel of the tools carried by said toolholder chassis at work. This bearing arm comprises a proximal part attached through a perpendicular-axis joint in the top part of the bearing frame of the mounting chassis and at least one axially-moving part for which the distal end is equipped with the toolholder head. The toolholder also comprises means to ensure the pivoting of said extensible bearing arm in perpendicular directions and means to ensure forward and backward movements of the sliding distal part of the latter.

According to an advantageous embodiment, the means ensuring the pivoting of the extensible bearing arm in a vertical or roughly vertical plane consist of a jack attached through one of its ends or using a joint in the vicinity of the front part of the fixed proximal part of said bearing arm, whose other end is arranged so as to be able to be attached also through a joint to a fixed lateral element of the carrier chassis.

According to a preferred embodiment, the extendable bearing arm consists of a telescopic jib, and the means ensuring extension and retraction of the sliding element of said bearing arm consist of a jack housed inside said telescopic jib, connecting the pivoting proximal part and sliding distal part of this telescopic jib.

According to an interesting embodiment, the multi-purpose toolholder under the invention comprises, away from the bearing arm and laterally in relation to the latter, a reinforcing structure comprising an upper link arm attached to the upper part of the bearing frame and oriented toward the front, and a rigid tie rod attached to the front end of said link arm and whose lower end is equipped with an attachment system making it possible to attach it to a fixed lower element of a tractor chassis. Preferably, the length of the upper link arm of this reinforcing structure can be adjusted, and the rigid tie rod is adjustable, the latter being connected to said arm through a swivel joint and its lower attachment system also comprising a swivel joint.

The purpose of this additional toolholder attachment using a rigid tie rod is to ensure proper triangulation of said toolholder attachment onto the tractor so as to guarantee excellent rigidity of the assembly and to limit significantly the deformations that might be caused by the weight of the tools hitched at the bearing arm end.

According to another construction example, the multi-purpose toolholder comprises two independent bearing arms or structures, away from each other and supported by the bearing frame of the mounting chassis.

According to another advantageous embodiment, the upper part of the mounting chassis bearing element for the multi-purpose toolholder under the invention is carried out in the form of a rollbar at the upper part of which the bearing arm and the reinforcing structure link arm are attached away from each other, or depending on the case, both bearing arms or other bearing structures.

Therefore, whenever the toolholder chassis is installed on a tractor, said top part of the main frame acts as a roll-over safety bar and enables the manufacturer of said tractor to be spared from having to mount the mandatory safety rollbar.

### BRIEF DESCRIPTION OF THE SEVERAL VIEWS OF THE DRAWINGS

The above purposes, characteristics and advantages and many more will become clearer from the description below and the attached drawings.

FIG. 1 is a perspective view of an embodiment of the multi-purpose toolholder under the invention.

FIG. 2 is a perspective view of the front showing this toolholder installed on a tractor and on the toolholder head where a tool consisting of a pre-pruning machine is installed.

FIG. 3 is a larger scale, detailed perspective view showing the system ensuring the jointed link of the bearing arm and bearing chassis.

FIG. 4 is a perspective view, seen from the rear, of the assembly shown in FIG. 2.

FIG. 5 is a detailed perspective view, showing the means of attachment of the bearing chassis onto a tractor.

FIG. 6 is a rear detailed perspective view showing the attachment of a tool onto the toolholder head.

FIG. 7 is a perspective view of a representation, seen from the rear, of an alternate attachment of the toolholder chassis onto a tractor three-point attachment system.

FIG. 8 is a perspective view from the front showing the use of the toolholder under the invention for the mounting of a two half-row topper.

FIG. 9 shows a rear perspective view, showing the same use as FIG. 8.

FIG. 10 is a perspective view showing a first embodiment of the system ensuring autoparalleling of the working axis of the tool mounted on the toolholder head and of the tractor axis at work.

FIG. 11 is a schematic view of this electromechanical system.

FIG. 12 is a perspective view showing a second embodiment of this system consisting of an electro-hydraulic device.

FIG. 13 is a schematic view of this electro-hydraulic system.

FIG. 14 is a perspective view showing a third embodiment of the autoparalleling system.

FIG. 15 is a schematic view of this hydraulic system.

FIG. 16 is a detailed schematic view of a drawing of the system of FIG. 15.

FIG. 17 is a perspective view showing an embodiment of a system that can be operated manually to ensure that the parallelism of the working axis of the tool mounted on the toolholder head and of the tractor axis when working.

FIGS. 18 and 19 are detailed schematic views of drawings of this device.

FIG. 20 is a perspective view showing a second embodiment of the multi-purpose toolholder under the invention.

FIG. 21 is a perspective view of a third embodiment of this toolholder.

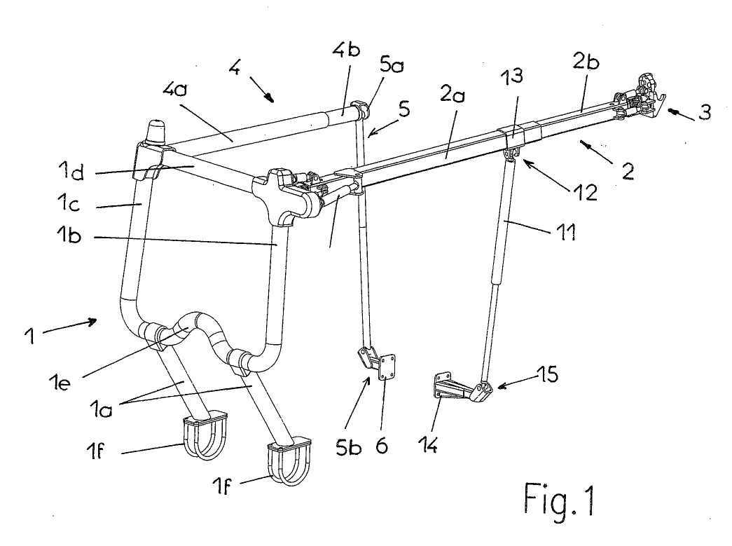

### DETAILED DESCRIPTION OF THE INVENTION

Said drawings are also referred to describe advantageous, although not limiting, embodiments of the multi-purpose toolholder under the invention.

Based on a particularly interesting application of the invention to grape and tree growing work, said invention is described below in connection with an agricultural tractor, but it is again stressed that the multi-purpose toolholder described hereinafter can be mounted on various types of carriers, including various models of agricultural tractors, especially vineyard row-crop tractors.

However, it is specified that the equipment under the invention can be installed on tractors with a mechanical transmission, or on tractors with electromechanical transmissions or on tractors with hydrostatic transmission.

Moreover, the use in the following text of terms such as “front”, “rear”, “upper”, “lower”, “top”; “horizontal”, “vertical” or alike was elected to simplify the description, based on the normal use position of the multi-purpose toolholder when working; however, it is understood that these are not restrictive.

The multi-purpose toolholder under the invention comprises a sturdy mounting chassis 1 whose bottom part 1a is arranged so as to permit its rigid, removable or fixed, attachment and positioning in the rear part of a carrier, such as a vineyard row-crop tractor T, or alike.

Such a mounting chassis 1 comprises a bearing frame extending upward, preferably in a vertical or roughly vertical plane.

According to the embodiment shown, this bearing frame comprises two parallel studs 1b, 1c at a distance from each other and assembled at their top through a top cross member 1d and at their base, through a bottom cross member 1e.

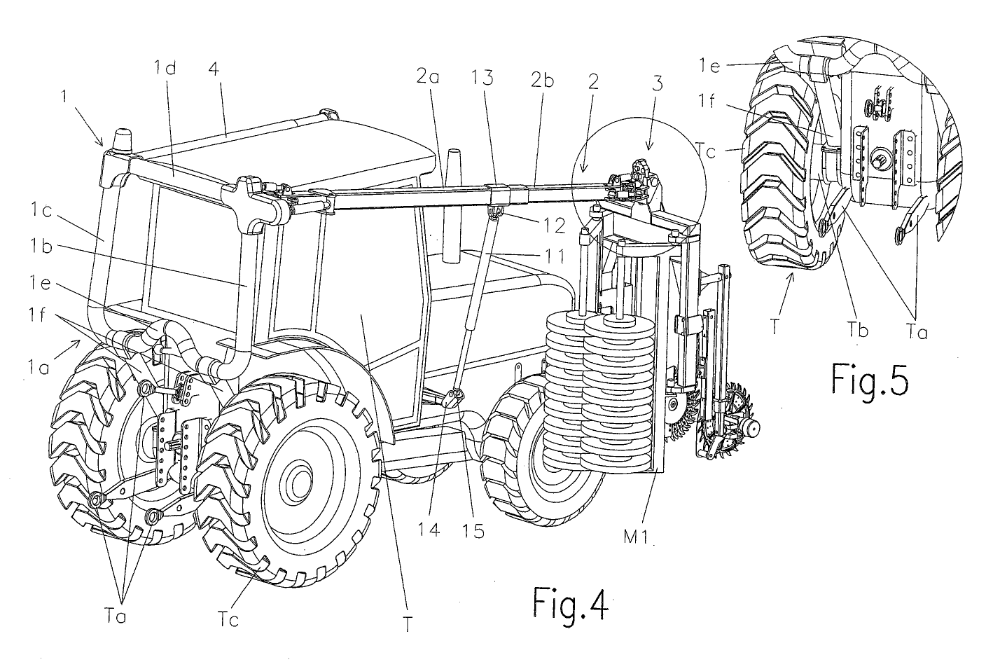

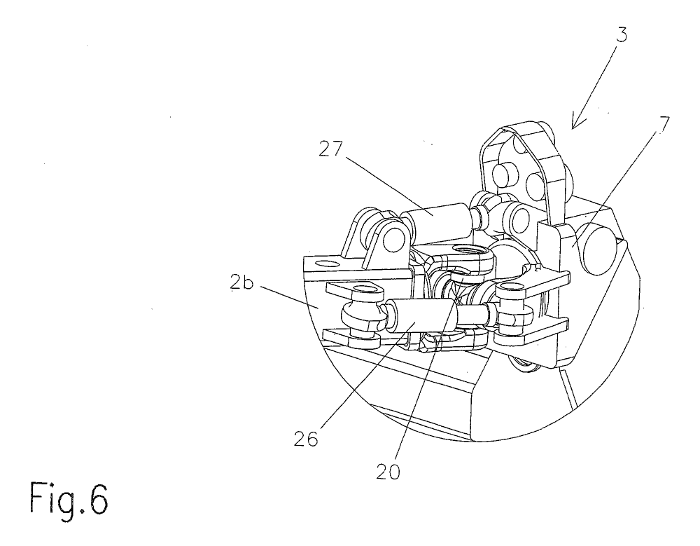

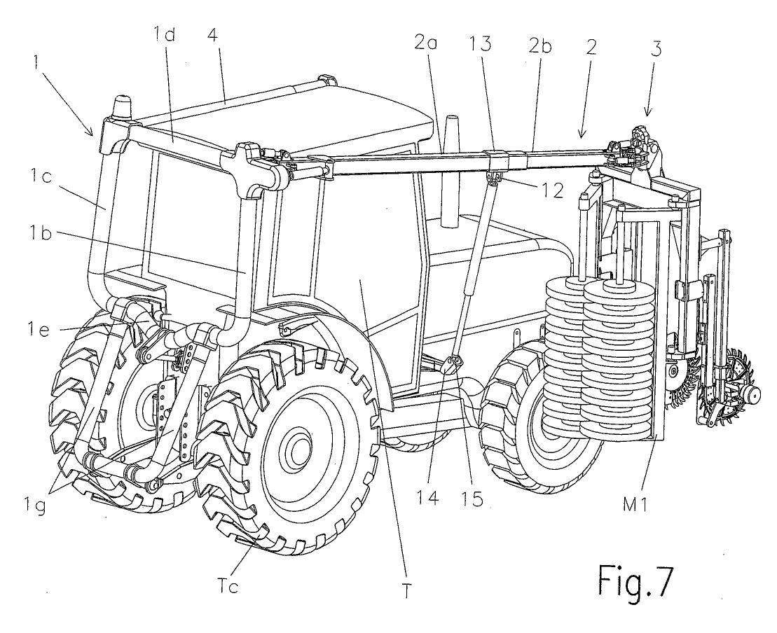

The bottom cross member 1e is equipped with mounting brackets 1f or 1g shaped to permit:
either removable mounting of the chassis 1 on the rear block of tractor T chassis or on the flared tubes Tb of the rear wheels Tc of said tractor (FIGS. 4 and 5), or on the rear three-point attachment system Ta of the latter (FIG. 7); or
fixed mounting of said chassis 1, directly on said rear block or on said flared tubes.

In the case of attachment of the chassis onto the tractor rear three-point, the mounting of another tool on the rear three-point system is of course much more complex.

Advantageously, the bottom part 1e-1f or 1e-1g of the chassis 1 is shaped so as to clear access to the rear three-point attachment system Ta of the tractor, when the toolholder is installed in the rear part of the latter so as to permit the hitching and use—concomitantly or not—of various machines or tools, for example tillage tools.

Moreover, the top part or bearing frame 1b-1c-1d of the mounting chassis, made as described above, constitutes a sturdy protective rollbar limiting the magnitude of potential bodily injury or physical damage in case the tractor rolls over.

In the top part of the bearing frame, for example, at the junction of elements 1b and 1d of the latter, a bearing structure is attached using a swivel system around two perpendicular axes, that, according to the described and shown examples, consists of an extendable bearing arm 2 oriented toward the front when considering the direction of travel of the machines or tools M1, M2, carried by the toolholder head 3 on the free end or distal end of said arm, when working. In other words, the extendable bearing arm 2 is mounted with a capability of swiveling in two perpendicular planes, either in a vertical or roughly vertical plane (downward or upward), and in horizontal or roughly horizontal plane (to the right or to the left).

According to a preferred embodiment, the extensible arm 2 consists of at least two tubular elements assembled in a telescopic manner, i.e., a proximal element 2a connected to the bearing frame 1b-1d and a distal element 2b, fitting with the capability of sliding inside said proximal element 2a and whose front end is equipped with the toolholder head 3.

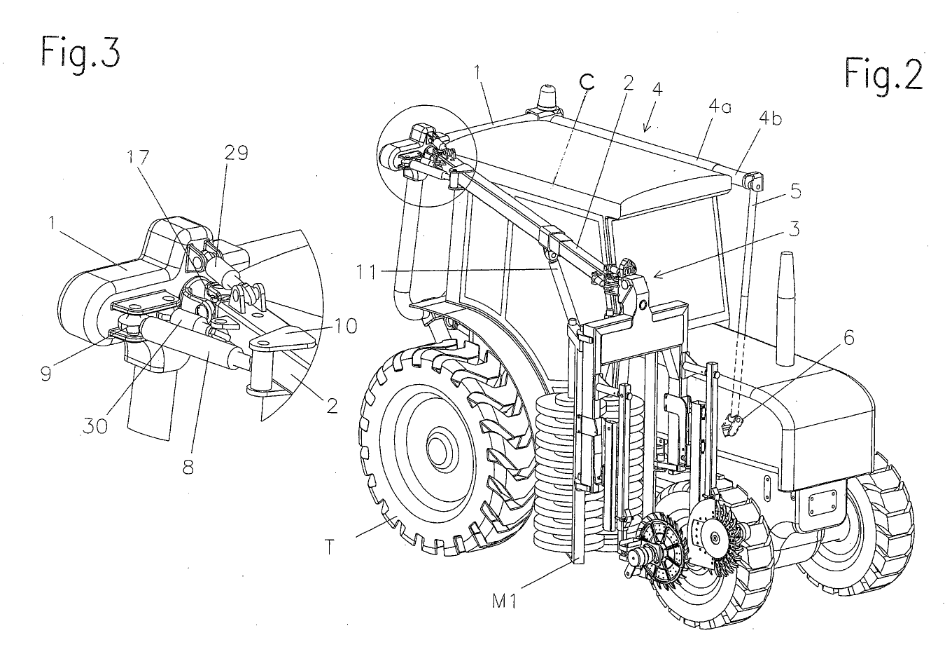

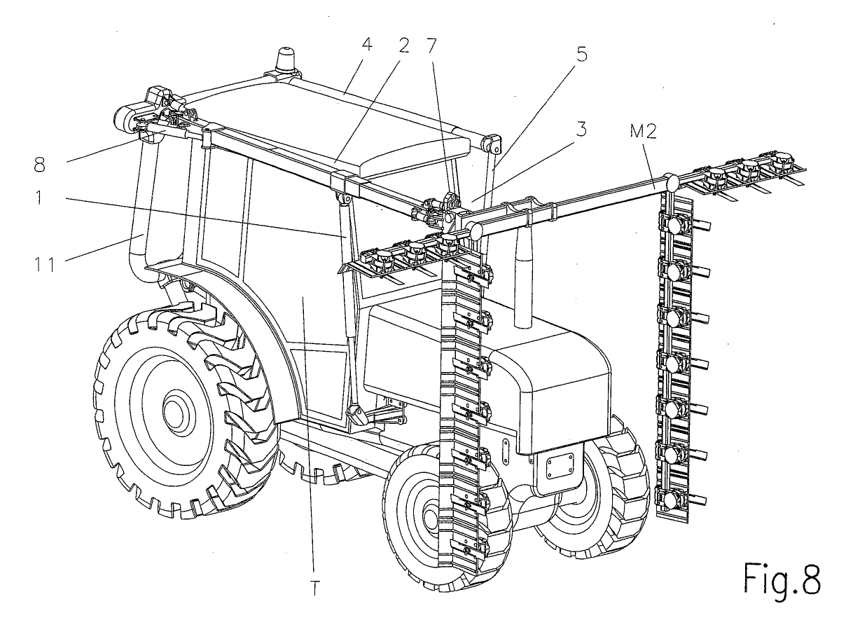

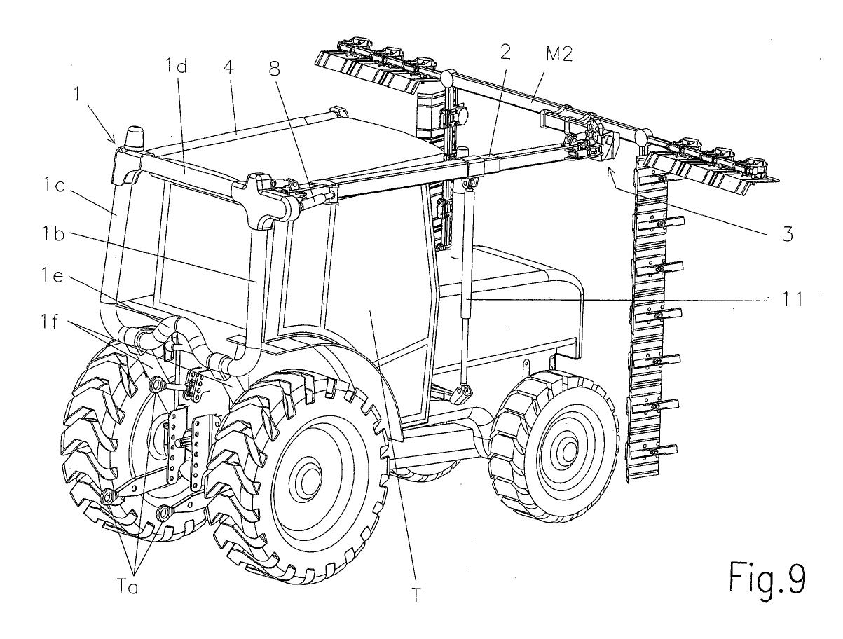

The toolholder head 3 is arranged so as to permit easy, quick and interchangeable attachment of tools intended for agricultural work, such as, for example, a pre-pruner M1 (FIGS. 2, 4 and 7) or a two half-row topper M2 (FIGS. 8 and 9), or similar tools.

Away from the bearing arm 2 and laterally in relation to the latter, the toolholder comprises a reinforcing structure comprising, on one hand, an upper link arm 4 attached to the upper part of the bearing frame 1b-1c-1d of chassis 1, for example at the junction of elements 1c and 1d of said frame, and oriented toward the front and, on the other hand, a rigid tie rod 5 connected to the front end of said link arm and whose lower end is provided with a fastening system 6 permitting to attach it to a fixed lower lateral element of tractor chassis.

Preferably, the length of the link arm 4 is adjustable, said arm consisting of, for example, two tubular elements 4a and 4b assembled in a telescopic manner. Moreover, the rigid tie rod 5 is adjustable and is connected through swivel joints 5a, 5b, to the front end of the link arm 4 and to its fastening system 6, respectively.

The bearing arm 2 is designed to fulfill three main functions:
ensure the interfacing of a tool or machine M1, M2, . . . , with a tractor, through the toolholder head 3;
permit the positioning of a tool or machine M1, M2, . . . , during work or road transport, in three directions X, Y, Z perpendicular to one another;
guarantee that the working axis of the tool or machine M1, M2, . . . , is always oriented parallel to the tractor axis, regardless of the correction made on X, Y or Z axes.

The toolholder under the invention comprises means permitting to achieve these functions.

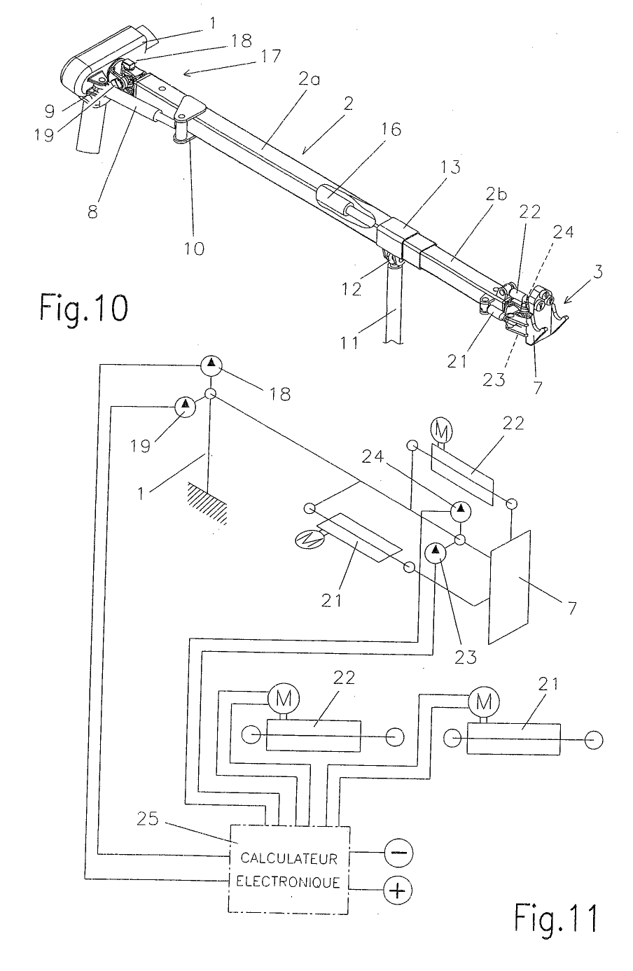

A jack 8, to be called “sideshift jack”, for example, consisting of a hydraulic jack, is attached through its opposite ends, at the top part of the rigid chassis 1 using a swivel joint 9 and a cylindrical joint 10, on one hand, and at the proximal part 2a of the bearing arm 2 (FIG. 10) on the other hand. This jack 8 ensures the lateral movement of said bearing arm in a horizontal or roughly horizontal plane, i.e., to the right or to the left, and in a space located on the side of the cabin C or of the tractor T piloting station.

A jack 11, to be called “height jack”, for example, consisting of a hydraulic jack, is connected through one of its ends, using a swivel joint 12 in the front of the proximal part 2a of the bearing arm 2. Advantageously, the jack 11 is attached onto the proximal part 2a, through an attachment flange 13 whose position on the proximal part is adjustable. The securing of this attachment flange at the desirable location is achieved through any well-known proper locking means (not represented). The function of this attachment flange 13 is to permit adjustment of the position of the height jack 11 along the axis of the bearing arm 2, so as to adapt to all possible configurations of tractors and tractor cabins.

The other end of the height jack 11 is shaped so as to be able to be attached directly onto a rigid lateral element of the chassis of a tractor T. Advantageously, the lower end of the height jack 11 is provided with a mounting bracket 14 to which it is connected through a swivel joint 15.

The height jack 11 ensures the movement of the bearing arm 2 in a vertical or roughly vertical plane, i.e., upward or downward.

Attachment of the height jack 11 through swivel joints 12, 15 permits self-aligning of said jack based on the position of the bearing arm 2 in the vertical and horizontal planes.

Attachment of the height jack 11 directly onto the tractor T is an especially important advantage, because, if one makes a static study of the complete bearing arm, consisting of elements 2a, 2b, 3 and of the tool M1 or M2, . . . , suspended from the toolholder head 3, one notes that triangulation of the stresses is conducive to high mechanical strength of said bearing arm and to very high rigidity of the assembly, especially when the toolholder is used for front mounting of a tool or machine, such as a two-half row topper M2 (FIGS. 8 and 9). This arrangement permits a much lighter bearing chassis 1 structure, thus being easier to be positioned rigidly on the rear part of the tractor. In addition, the attachment stresses, of the main chassis assembly 1 and of the bearing arm assembly 2-3 on tractor T, are better distributed as the height jack 11 absorbs a majority thereof directly without going through a heavy chassis structure.

A jack 16, to be called “sliding jack” connects through its opposite ends the proximal part 2a and the distal part 2b of the bearing arm 2. Preferably, this sliding jack is housed inside the telescopic bearing arm 2. It ensures the longitudinal travel of the sliding distal part 2a of the latter, equipped with the toolholder head 3, i.e., toward the front or the rear.

In order to guarantee that the working axis of the tool M1 or M2 suspended from the toolholder head 3 is always parallel to the tractor T axis, regardless of the position of said toolholder head achieved by the jacks 8, 11 and 16, in the directions X, Y, Z, respectively, the multi-purpose toolholder under the invention is provided with a device acting as a double deformable parallelogram in the horizontal and vertical planes. To that effect, the ends of the bearing arm 2 are attached to a servo system comprising means of detection of the angular movements of said bearing arm around its perpendicular joint axes and means ensuring self-positioning of the tool holder head 3 based on the movements of said arm detected by said means of detection.

Several methods are possible to implement this virtual deformable double parallelogram, as described below.

According to FIGS. 10 and 11, the proximal end of the bearing arm 2, consisting of elements 2a, 2b, is attached through a double joint, for example a Cardan link 17, in the top part of the bearing chassis 1 so as to allow only for two degrees free of rotation permitting the travel of said arm in two perpendicular planes. Two angular sensors are attached onto the Cardan axes 17 or other double joint link device. A sensor 18 is attached onto the Cardan permitting rotation of the bearing arm 2 in an horizontal plane and thus free movement of the tool M1 or M2 in the X direction. The second sensor 19 is attached onto the Cardan axis, permitting rotation of the bearing arm in a vertical plane and thus ensuring free movement of the tool M1 or M2 in a plane Y.

The distal end of bearing arm 2 is also connected through a double joint link, for example a Cardan joint 20 to the quick hitch fitting 7 constituting the major part of the toolholder head 3. Two small electric jacks 21, 22, also connecting said distal end and said quick hitch fitting 7, are controlled through two angular sensors 23, 24 located on both Cardan joint axes 20 for attachment of the quick hitch fitting 7 and an electronic calculator 25, in servo loop for readback of the angles measured by the angular sensors 18 and 19, in order to guarantee that the position axis of the quick hitch fitting 7, and thus, the tool M1 or M2 suspended from the latter is always parallel to the axis of tractor T.

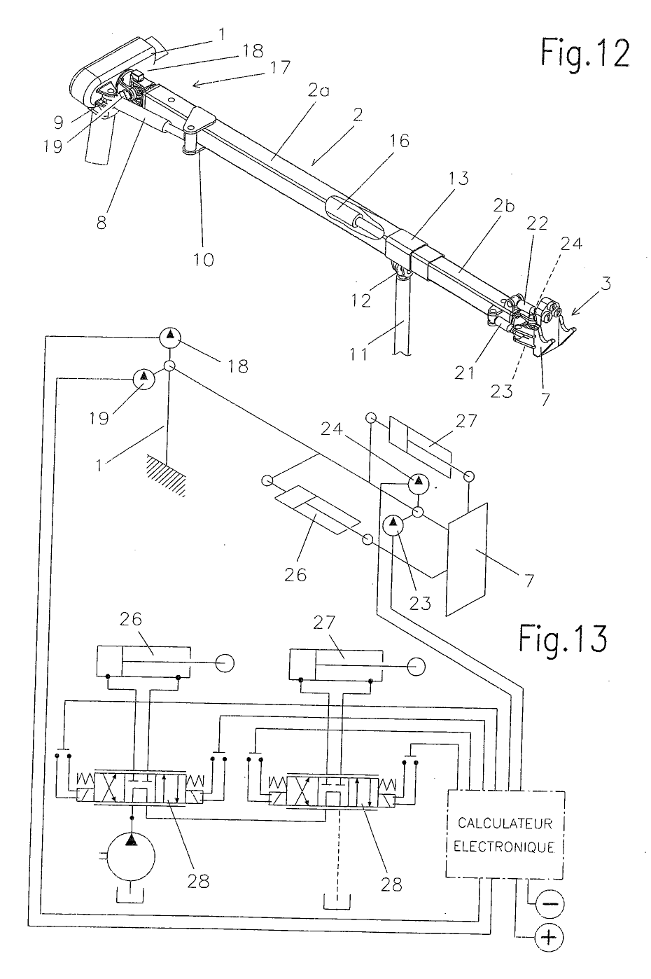

The embodiment shown in FIGS. 12 and 13 differs from the preceding one in that the jacks 26 and 27 ensuring the orientation of the quick hitch fitting 7 consist of double-acting hydraulic or pneumatic jacks and are controlled through the angular sensors 23, 24 located on both axes of the Cardan joint 20 (or other double-joint linking device) for attachment of the quick hitch fitting 7 at the distal end of the bearing arm 2, the electronic calculator 25, and two electro distributors, or servo distributors or servo valves 28, in servo loop for readback of the angles measured by the angular sensors 18 and 19. This embodiment also permits one to guarantee that the position axis of the quick hitch fitting and thus of the tool M1 or M2 is always parallel to the axis of the tractor T.

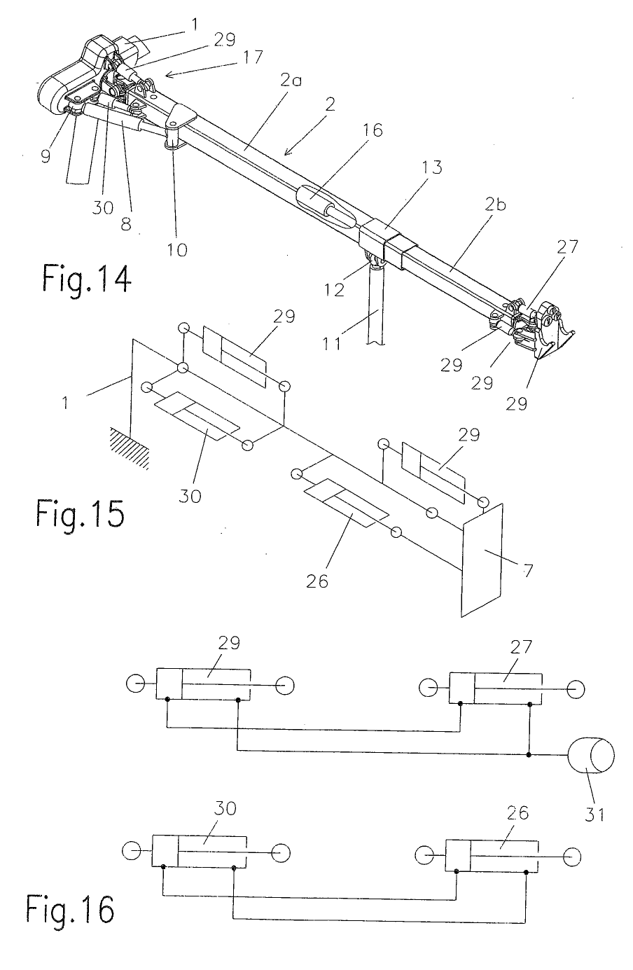

According to the embodiment shown in FIGS. 14, 15, and 16, self-positioning of the quick hitch fitting is achieved using a volumetric hydraulic double parallelogram. The toolholder 3 is connected to the distal end of the bearing arm 2 through a double-joint link, for example, through a Cardan joint link 20 and through two small double-acting hydraulic jacks 26 and 27, as indicated above. Moreover, the proximal end of the bearing arm 2 is connected to the top part of the chassis 1 using a double-joint link 17 and two small double-acting hydraulic jacks 29 and 30 placed so that one (29) is actuated through extension or retraction movements of the height bearing 11, i.e. through movements of the arm in a vertical or roughly vertical plan. The other one (30) is actuated through extension or retraction of the sideshift jack 8, i.e., through the movements of the arm in an horizontal or approximately horizontal plane.

Compression of the jack 29, for example, due to upward pivoting of the bearing arm 2, causes transfer of oil into one of the chambers of jack 27, extension of the latter causing downward pivoting of the quick hitch fitting 7 that remains oriented vertically and vice versa. Compression of the jack 30, for example due to pivoting to the right of the bearing arm 2, causes transfer of oil into one of the chambers of jack 26 and extension of the latter causing a pivoting to the left movement of the quick hitch link 7 whose position axis and thus the axis of tool M1 or M2 suspended from said fitting remain parallel to the tractor axis.

It is understood that each oil transfer, for example from jack 29 to jack 27 is double-acting. Oil transfer is indeed double so as to maintain the operation of the deformable hydraulic parallelogram, regardless of the direction of the stresses generated by gravity or by the working tool. Jacks 29 and 27 ensure the operation of the parallelogram in a vertical or roughly vertical plane, while jacks 30 and 26 ensure the operation of the parallelogram in an horizontal or roughly horizontal plane.

An air oil accumulator 31, for example connected to jack 27 (FIG. 16a), rod side, i.e., the side where the hydraulic pressure opposes the direction of forward travel of the tool M1 or M2, under normal working conditions, ensures the operation of the hydraulic safety based on the inflation pressure Po of the accumulator that regulates the resisting strength of said hydraulic parallelogram jack.

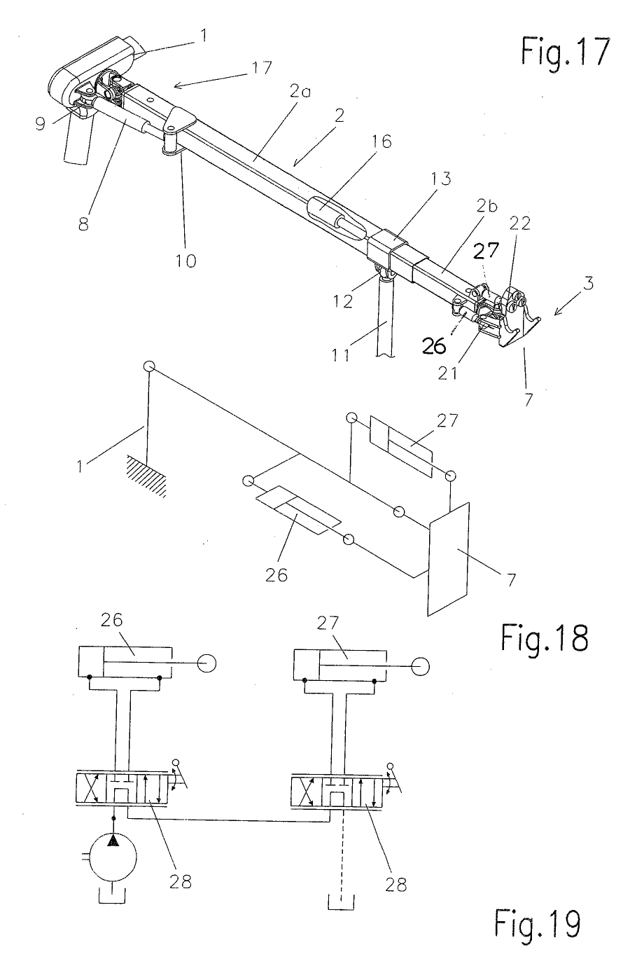

According to another embodiment shown in FIGS. 17, 18 and 19, means permitting to ensure the parallelism of the working axis of tool M1 or M2 suspended from the toolholder head 3 with the tractor T axis can be operated manually. In this case, two orthogonal jacks 26, 27 connect the distal end of the bearing arm 2 and the quick hitch fitting 7 of the toolholder head 3. These jacks are able to be operated manually through two electro distributors, or servo distributors or servo valves 28.

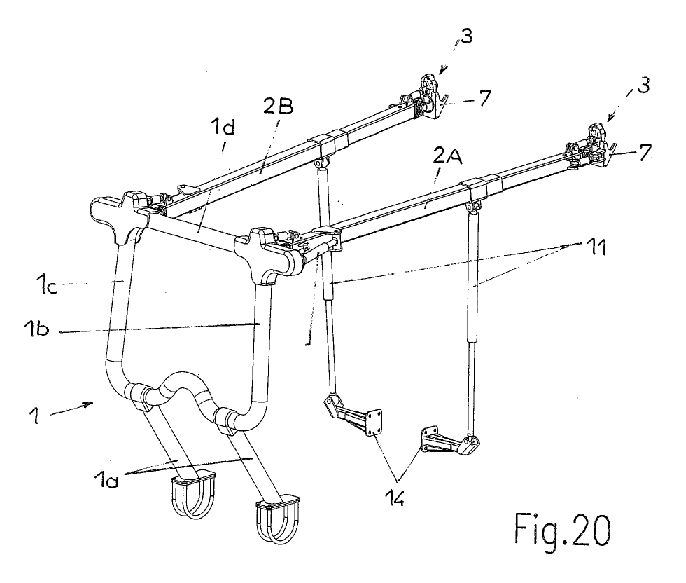

According to the embodiment shown in FIG. 20, the multi-purpose toolholder under the invention comprises two independent bearing structures or bearing arms 2A, 2B, distant from each other and supported by the bearing frame 1b-1c-1d of the mounting chassis 1. These bearing arms 2A, 2B are shaped and equipped in a manner similar to that of the bearing arm 2 described above, and they are for example, attached at the junction of elements 1b, 1d or 1c, 1d, respectively, of the bearing frame, in the manner described above. These independent bearing arms 1A, 2B can move laterally in spaces located on the right and left sides, respectively, of the cabin C or of the piloting station when the toolholder is mounted on such carrier.

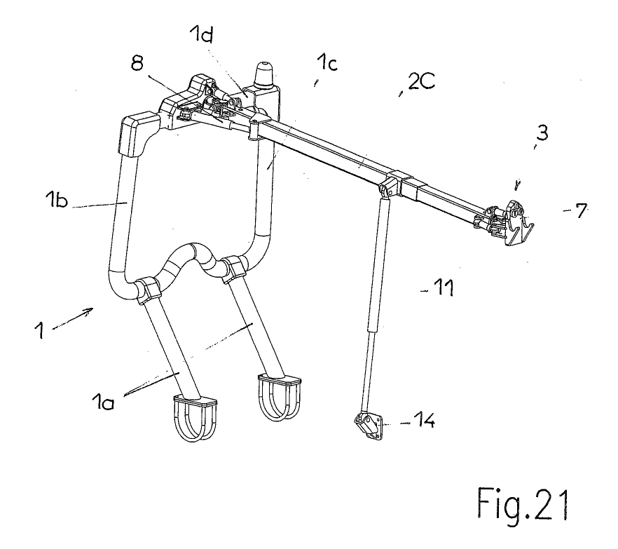

According to the embodiment represented in FIG. 21, the sole bearing arm 2C of the multi-purpose toolholder under the invention, is attached in the middle part of the upper cross member 1d of the bearing frame 1b-1c-1d of the mounting chassis 1. In this case, this bearing arm 2C can move laterally, in a space located above the cabin C or piloting station of the tractor, whenever the toolholder is mounted on a tractor.

1. Multi-purpose toolholder attaching onto a rear part of a carrier, for example the rear part of an agricultural tractor, the toolholder comprising:
a mounting chassis having a bottom part arranged to permit attachment and positioning in said rear part of said carrier, said mounting chassis comprising:
at least one load-bearing frame extending upward, in the rear of the carrier and mounted on the rear of the carrier; and
at least one bearing structure with a toolholder head arranged so as to permit interchangeable attachment of tools for various agricultural work, said bearing structured being connected to an upper part of said at least one load-bearing frame and oriented toward a front, considering direction of travel of one of the tool s suspended from said toolholder head, while working, said bearing structure being arranged so as to permit movements of said toolholder head in three directions, vertically, laterally, and longitudinally, said toolholder head traveling a space located in a front and/or on at least one side of the carrier.

2. Multi-purpose toolholder according to claim 1, wherein said toolholder head is attached to means ensuring auto-paralleling of a working axis of the tool carried by said toolholder head with a tractor axis.

3. Multi-purpose toolholder according to claim 1, wherein said toolholder head is attached to two orthogonal jacks being operated manually and being installed in a front of said bearing structure, the jacks permitting to ensure parallelism of a working axis of the tool carried by said toolholder head with a tractor axis.

4. Multi-purpose toolholder according to claim 1, further comprising:
two independent bearing arms distant from each other and supported by a bearing element of said mounting chassis.

5. Multi-purpose toolholder according to claim 1, wherein a bottom part of said mounting chassis is shaped so as to clear access to a rear three-point attachment system, whenever the toolholder is installed on a tractor equipped with said rear three-point attachment system.

6. Multi-purpose toolholder according to claim 1, wherein said bearing structure comprises a bearing arm comprising a proximal part attached through a perpendicular-axis joint in an upper part of the bearing element and at least one axially-moving part having a distal end equipped with said toolholder head, said toolholder comprising means to ensure pivoting of said bearing arm in perpendicular directions and means to ensure forward and backward movements of the the axially-moving part, said bearing arm being telescopic, the axially-moving part being slidable.

7. Multi-purpose toolholder according to claim 6, wherein said bearing arm is moveable laterally in a space located on a side of a cabin or of a piloting station of a tractor.

8. Multi-purpose toolholder according to claim 6, wherein said bearing arm is moveable laterally in a space located above a cabin or a piloting station of a tractor.

9. Multi-purpose toolholder according to claim 6, wherein said means that ensure pivoting of said bearing arm is placed in a vertical or roughly vertical plane, the means comprising a height jack attached through one end and a joint (12) at a distal end of said proximal part of said bearing arm, an opposite end being arranged so as to be able to be attached also through a joint and a fixed lateral element of a chassis of the carrier.

10. Multi-purpose toolholder according to claim 9, wherein the height jack is attached onto a flange with an adjustable position mounted on the pivoting proximal part of said bearing arm.

11. Multi-purpose toolholder according to claim 9, wherein the height jack is connected to the bearing arm and to a fastener, said fastener attaching to a fixed lateral element of a chassis of the carrier and using swivel joints.

12. Multi-purpose toolholder according to claim 6, wherein said bearing arm is comprised of a telescopic jib, wherein said axially-moving part has a means ensuring extension and retraction movements thereof, said means ensuring extension and retraction movements being comprised of a jack housed inside said telescopic jib, connecting said proximal part and the said axially-moving part.

13. Multi-purpose toolholder according to claim 1, further comprising:
a reinforcing structure comprising an upper link arm oriented toward a front of the carrier and a rigid tie rod attached to an end of said upper link arm, said rigid tie rod having a lower end equipped with an fastening system permitting attachment to a fixed lower lateral element of a tractor chassis, said reinforcing structure being positioned away from said bearing arm and being in lateral relation to said bearing arm.

14. Multi-purpose toolholder according to claim 13, wherein said upper link arm being extendable, said upper link arm being comprised of two tubular elements assembled in a telescopic manner, said tie rod being adjustable.

15. Multi-purpose toolholder according to claim 13, wherein said tie rod is connected to said upper link arm and to a lower fastening system, through swivel joints.

16. Multi-purpose toolholder according to claim 1, wherein said mounting chassis has a top part formed of a roll-over bar, the upper bearing arm and the upper link arm or both bearing arms being attached away from each other at an upper part of the top part.

17. Multi-purpose toolholder according to claim 6, wherein the ends of the bearing tool arm are attached to a servo system comprising means of detection of angular movements of said bearing arm around joint axes thereof in a top part of the chassis, and means ensuring self-positioning of said toolholder head based on movements of said bearing arm detected by said means of detection.

18. Multi-purpose toolholder according to claim 17, wherein the proximal end of the bearing arm is attached to the top part of the mounting chassis through a double-joint link, being a Cardan joint link, said double-joint link having perpendicular axes, each being provided with an angular sensor, a distal end of said bearing arm being connected to said toolholder head through a double-joint link, the double-joint link being a Cardan joint link, two electric jacks connecting said distal end and said toolholder head, the jacks being servo controlled through two angular sensors located on both Cardan joint axes for attachment of said toolholder head and an electronic calculator, in servo loop for readback of angles measured by angular sensors.

19. Multi-purpose toolholder according to claim 18, wherein the proximal end of the bearing arm (2) is attached to the top part of the mounting chassis through a double-joint link, said double-joint link being a Cardan joint link and having perpendicular axes, each link being provided with an angular sensor, the distal end of said bearing arm being connected to said toolholder head through a double-joint link, the link being a Cardan joint link, two hydraulic jacks connecting said distal end and said toolholder head, the jacks being servo controlled through two angular sensors located on both Cardan joint axes for attachment of said toolholder head, an electronic calculator and two electro distributors, servo distributors or servo valves, in servo loop for readback of angles measured by angular sensors.

20. Multi-purpose toolholder according to claim 19, wherein said toolholder is connected to the distal end of the bearing arm through a double-joint link, the link being a Cardan joint, through two double-acting jacks, the proximal end of bearing arm being connected to a top part of the mounting chassis through a double-joint link, the link being a Cardan link, and two double-acting hydraulic jacks placed so that one jack is actuated by extension or retraction movements of a height jack, movements of the bearing arm in a vertical or roughly vertical plane while another jack is actuated by extension or retraction movements of a sideshift jack, movements of the bearing arm in an horizontal or approximately horizontal plane, each jack being connected to a distal jack through a double circuit so that extension of a proximal extension causes retraction of the distal jack to be doubly connected, and vice versa, so as to make a deformable hydraulic parallelogram.

21. Multi-purpose toolholder according to claim 19, further comprising:
an air oil accumulator connected to the jack ensuring pivoting movements of said toolholder head downward or upward, the accumulator being in communication with the chamber run through by the rod of the jack.
